(19) United States
(12) Patent Application Publication
(10) Pub. No.: US 2015/0060195 A1
(43) Pub. Date: Mar. 5, 2015

(54) Harness with Integral Relief Loops for Suspension Trauma

(71) Applicant: Honeywell International Inc., Morristown, NJ (US)

(72) Inventors: Steven J. Sharp, Pleasantville, PA (US); Michael R. Seman, Cranberry Township, PA (US); Eric M. Mason, Franklin, PA (US); Ross Balquist, Slippery Rock, PA (US)

(73) Assignee: Honeywell International Inc., Morristown, NJ (US)

(21) Appl. No.: 14/017,878

(22) Filed: Sep. 4, 2013

(51) Int. Cl. A62B 35/00

(52) U.S. Cl. CPC A62B 35/0025; A62B 35/0018; A62B 35/0012
USPC 182/3

(57) ABSTRACT

A safety harness (10) is provided to be worn by a person and to allow the person to manipulate the harness (10) to alleviate the potential effects of orthostatic intolerance in the person while suspended by the harness (10). The harness (10) includes one or more hand engageable members (102) allow the person to selectively repositioning a strap (70, 80, 90) of the harness (10) from a first position where the strap (70, 80, 90) extends across an upper portion of a lower torso of the person and a second position where the strap (70, 80, 90) extends across a lower portion of the lower torso of the person.

### CROSS-REFERENCE TO RELATED APPLICATIONS

Not Applicable,

### FEDERALLY SPONSORED RESEARCH OR DEVELOPMENT

Not Applicable.

### MICROFICHE/COPYRIGHT REFERENCE

Not Applicable.

### FIELD

This disclosure relates to safety equipment and harnesses, and in more particular applications, to fall protection equipment in the form of safety harnesses that are worn by people who are at risk of falling from an elevated location.

### BACKGROUND

Safety harnesses are commonly used as part of a fall protection system for persons subjected to the potential of a fall from a height. In the workplace, full-body safety harnesses are generally used. Such harnesses, which typically include both an upper torso portion (having, for example, shoulder straps) and a lower torso portion (having, for example seat straps and leg straps), can be designed in many alternative manners.

Many currently available full-body safety harnesses are manufactured from relatively inelastic, woven webbing materials such as nylon or polyester. A flexible and elastic harness, as described in U.S. Pat. No. 6,006,700, has been introduced that greatly improves the comfort of the user during normal use of the safety harness. A safety harness with blunted edges for further increasing the comfort of the user is disclosed in U.S. Pat. No. 6,739,427. These documents can be referenced for an understanding of the materials and constructions of some examples of harness with which the features disclosed herein can be employed.

Although the comfort of safety harnesses during normal use and even during a fall arrest has been greatly improved in the above-described harnesses, problems can still arise in the case that a harness user is suspended in a safety harness for a substantial period of time after a fall. In that regard, orthostatic intolerance/suspension trauma, including unconsciousness and even death, may be experienced by an individual using a fall protection safety harness if the individual remains suspended in the harness for a length of time. Typically, a person suspended in a fall protection system is suspended in an upright static position in which venous pooling can lead to orthostatic intolerance/suspension trauma. For example, pooling of blood can occur in the legs do to the pressure created by the leg straps of a harness while supporting the weight of the victim, with this pooling of blood subsequently restricting the flow of blood to the brain and other major organs which may cause unconsciousness. Thus, venous pooling and orthostatic intolerance can lead to a serious injury and even death as the brain and other vital organs are deprived of oxygen.

For the above reasons, it is recommended that individual in a safety harness should not work alone, and, in the case of suspension after a fall, the suspended individual should be rescued as soon as possible. It is further recommended, for example, that an individual using a harness be trained to try to move their legs while suspended in the harness and to push against any available footholds in an attempt to prevent venous pooling.

Because the average fall rescue time is 15 minutes, the need arises for victim to be able to relieve the pressure of the leg straps around the legs to avoid succumbing to suspension trauma.

One prior solution is shown in US 2005/0194211 A1, which discloses a pair of footholds that can be used to remove pressure/load from the leg straps of a safety harness. Two of them are required for proper use. This is a secondary product that may be purchased and added onto a harness if the end user so desires to do so, however at least one manufacturer provides a harness than includes such a feature,

### SUMMARY

In accordance with one feature of this disclosure, a safety harness is provided to be worn by a person. The safety harness includes at least one of a pair of leg straps, each adapted to encircle a respective leg of a person wearing the harness, each of the leg straps moveable between a first position where the leg strap encircles an upper thigh portion of a leg of a person wearing the strap and a second position wherein the strap encircles a lower thigh portion of the leg of the person; and a seat strap adapted to extend across the buttocks of a person wearing the harness and operatively connected to the leg straps, the seat strap moveable from a first position extending across or above the upper buttocks of a person wearing the harness and a second position extending across or below the lower buttocks of a person wearing the harness. The harness further includes at least one hand engageable member operatively connected to the at least one of the pair of leg straps and the seat strap to allow a person wearing the harness to move the at least one of the pair of leg straps and the seat strap between the first and second positions with the harness bearing the weight of the person.

As one feature, the at least one hand engageable member is a loop extending from the at least one of pair of leg straps and the seat strap and adapted for engagement by a hand a person wearing the harness. In a further feature, the loop includes a strap fixed to the at least one of the leg straps and seat strap. In yet a further feature, the loop is a thumb or finger loop sized to accept a thumb of a person wearing the harness but not the remainder of a hand of the person.

In one feature, the at least one hand engageable member is a pair of loops operatively connected to the at least one of the leg straps and the seat strap, the loops located on the harness to be positioned on opposite sides of a buttocks from each other on a person wearing the safety harness. In a further feature, each of the loops is a thumb or finger loop sized to accept a thumb of a person wearing the harness but not the remainder of a hand of the person

According to one feature, the at least one of the leg straps and the seat strap includes the seat strap, and the at least one hand engageable member is operatively connected to the seat strap to allow a person wearing the harness to move the seat strap from the first position to the second position. In a further feature, the at least one hand engageable member is a pair of loops operatively connected to the seat strap, the loops located on the harness to be positioned on opposite sides of a buttocks from each other of a person wearing the safety harness.

As one feature, the at least one of the leg straps and the seat strap includes the leg straps, and the at least one hand engageable member is operatively connected to the leg straps to allow a person wearing the harness to move the leg straps from the first position to the second position. In a further feature, the at least one hand engageable member is a pair of loops operatively connected to the leg straps, the loops located on the harness to be positioned on opposite sides of a buttocks from each other on a person wearing the safety harness. In yet a further feature, the at least one of the leg straps and seat strap further includes the seat strap, with each of the loops being fixed to the seat strap and to a corresponding one of the leg straps to allow a person wearing the harness to move the seat strap and the leg straps from the first positions to the second positions. In yet a further feature, each of the loops includes a strap fixed to the seat strap and a corresponding one of the leg straps. As an additional feature, each of the loops is sized to accept a thumb of a person wearing the harness but not the remainder of a hand of the person. As yet a further feature, the leg straps, the seat strap and the at least one hand engageable member define a lower seat portion of the harness, and the harness further includes an upper torso portion operatively connected to the lower seat portion and adapted to secure the harness to the upper torso of a person wearing the harness. As an additional feature, the upper torso portion includes a pair of shoulder straps operatively connected to the lower seat portion, each of the shoulder straps configured to extend over a respective shoulder of a person wearing the strap.

In accordance with one feature of this disclosure, a method is provided for manipulating a safety harness to alleviate the potential effects of orthostatic intolerance in a person wearing the harness while suspended thereby. The method includes the steps of loading a safety harness with a weight of a person wearing the harness; and while the safety harness is loaded with the weight of the person wearing the harness, selectively repositioning a strap of the harness from a first position where the strap extends across an upper portion of a lower torso of the person wearing the harness and a second position where the strap extends across a lower portion of the lower torso of the person wearing the harness.

As a one feature, the step of selectively repositioning includes the step of selectively repositioning at least one leg strap of the harness from a first position where the strap extends around an upper thigh of a leg of the person wearing the harness to a lower position on the thigh of the leg of the person.

In one feature, the step of selectively repositioning includes the step of selectively repositioning a seat strap of the harness from a first position where the strap extends across or above an upper portion of a buttocks of the person wearing the harness to a lower portion of the buttocks or thighs of the person wearing the harness.

According to one feature, the step of selectively repositioning includes the step of engaging each hand of the person with a corresponding harness member extending from the strap and using the hands to move the strap to the second position. In a further feature, the engaging step includes inserting one of a finger or thumb of each hand of the person into a corresponding loop extending from the strap.

Other features and advantages will become apparent from a review of the entire specification, including the appended claims and drawings.

### BRIEF DESCRIPTION OF THE DRAWINGS

FIG. 1 is a somewhat diagrammatic front view of a person wearing the safety harness of FIG. 3;

FIG. 2 is a somewhat diagrammatic rear view of a person wearing the safety harness of FIG. 3;

FIG. 3 is a somewhat diagrammatic illustration of a safety harness embodiment of this disclosure;

FIG. 4 is an enlarged rear view of a person wearing the safety harness of FIGS. 1-3 and better illustrating selected features of the harness of FIG. 1;

FIG. 5 is a perspective view from the right rear side of a person wearing the harness of FIGS. 1-4, with the harness bearing the weight of the person;

FIG. 6 is a view similar to FIG. 5, but showing the person engaging selected components of the harness so as to reposition selected straps of the harness on the body of the person;

FIG. 7 is a view similar to FIGS. 5 and 6, but showing the selected straps of the harness after they have been repositioned on the body of the person while the harness bears the weight of the person and the person is still engaging the selected components of the harness; and

FIG. 8 is a view similar to FIG. 7, but with the person no longer engaging the selected components of the harness.

### DETAILED DESCRIPTION

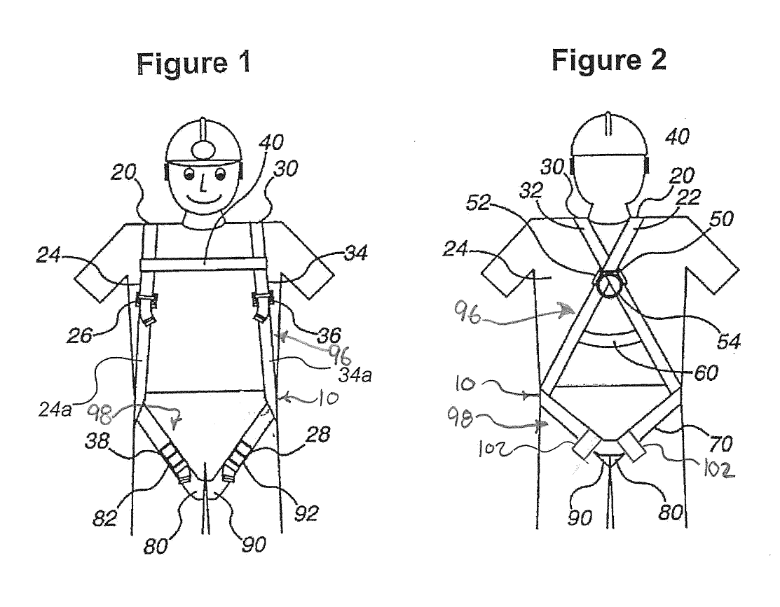

Referring to FIG. 1, an embodiment of a full-body safety harness 10 of the present disclosure is discussed below. The overall structural design of safety harness 10 corresponds generally, for example, to the DURAFLEX ULTRA Model safety harness, model E650QC-UGN, available from Miller By Honeywell. Safety harness 10 includes an upper torso portion comprising first and second shoulder straps 20 and 30 for extending over the shoulders of the user and a chest strap 40 (see FIGS. 1-2) for extending over a portion of the chest of the user to secure the harness 10 to the upper torso of the user.

As illustrated in FIG. 2, a first end of each of the shoulder straps 20 and 30 extends down over the back of the user to form first and second generally longitudinal back straps 22 and 32, respectively. Longitudinal back straps 22 and 32 of shoulder straps 20 and 30 cross through and connect to a typical D-ring 50 as known in the art. D-ring 50 includes a harness connection portion 52 and an anchor portion 54. Harness connection portion 52 enables fastening of D-ring 50 to safety harness 10 via longitudinal back straps 22 and 32. Anchor portion 54 is adapted to be connected to a nylon rope, a chain, webbing or other connector which may be used to anchor the person wearing safety harness 10.

In the embodiment illustrated in FIG. 2, after crossing and passing through D-ring 50, shoulder straps 20 and 30 are connected via a generally latitudinal back strap 60. As illustrated in FIG. 2, latitudinal back strap 60 passes generally latitudinally over a portion of the back of the user.

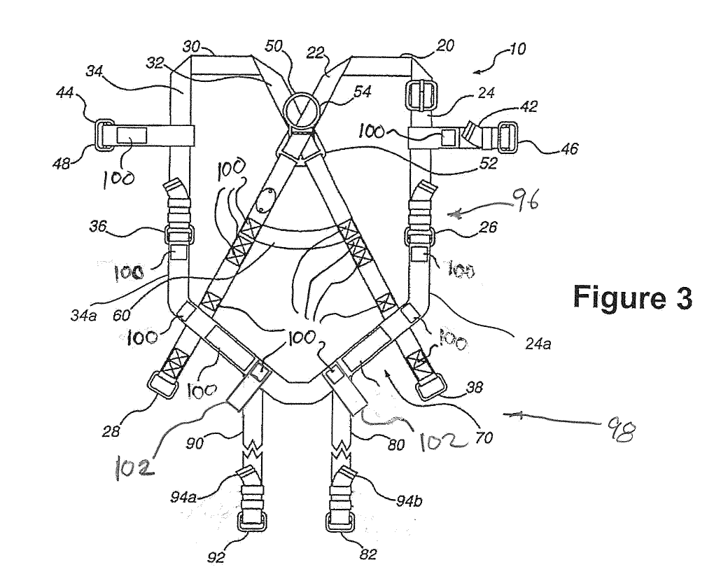

A second end of each of shoulder straps 20 and 30 extends downward over the front of the user as illustrated in FIG. 1 to from generally longitudinal first and second front straps 24 and 34, respectively. As best seen in FIG. 3, a first chest strap portion 42 is preferably attached to front strap 24 and a second chest strap portion 44 is attached to front strap 34. Each of first and second chest straps 42 and 44 have cooperating fastening members 46 and 48 on the ends thereof to enable attachment of first and second chest straps 42 and 44 to form chest strap 40. As known in the art, first and second chest straps 42 and 44, respectively, are preferably attached via an adjustable mating buckle mechanism, including, for example, cooperating fastening members 46 and 48.

First and second front straps 24 and 34 extend further downward and preferably include adjustment members 26 and 36 (for example, adjustable buckles) as known in the art for adjustment of the fit of safety harness 10 on the upper torso of the user. Extending still further downward as illustrated in FIG. 1, extensions 24a and 34a of first and second front straps 24 and 34 converge and meet generally centrally to form a seat strap or sub-pelvic portion 70. As illustrated in FIGS. 2 and 3, first and second front extension straps 24a and 34a pass to the rear of the user and seat strap 70 passes under the pelvis and behind the buttocks of the user.

As shown in the illustrated embodiment, attached to and extending from seat strap 70 are a first and a second leg strap 80 and 90, respectively. Each of first and second leg straps 80 and 90 pass around the upper leg or thigh of a corresponding leg of the user to be attached to the distal end of first and second longitudinal back straps 22 and 32, respectively. The distal ends of each of first and second leg straps 80 and 90 and the distal ends of each of longitudinal back straps 22 and 32 thus preferably comprise cooperating fastening members (82 and 92 and 28 and 38, respectively) such as adjusting buckle members as known in the art.

It will be appreciated by those skilled in the art that, in the illustrated embodiment, the straps 20, 22, 24, 30, 32, 34, 40, and 60 define an upper torso portion 96 of the harness 10 that secures the harness 10 to the upper torso of a person, while the straps 70, 80, and 90 define a lower torso portion 98 of the harness 10 that secures the harness 10 to the lower torso of a person.

In the design of FIGS. 1-3, the bottom portion of safety harness 10 can, for example, be fabricated from a single, integral length of material. In that regard, the length of material as described above begins at first end 94a on leg strap 90. The material then travels downward through fastening member 92 and then travels upward toward seat portion 70, thereby forming leg strap 90. Upon reaching seat portion 70, the material travels along the path identified by the left side of seat portion 70, forming the back side thereof. The material travels to adjustment member 36 at which point it is preferably looped around or through adjustment member 36. The material then travels downward (doubling itself) over the lower portion of longitudinal front strap 34 and the left side of seat portion 70. The material the travels across the center of seat portion 70 and upward along the path defined by the right side of seat, portion 70. Upon reaching adjustment member 26, the material is preferably looped around or through adjustment member 26. After looping through adjustment member 26, the material travels downward (doubling itself) under the lower portion of longitudinal front strap 24 and the right side of seat portion 70. Before reaching the center of seat portion 70, the material breaks away from the path of seat portion 70 to extend downward to from leg strap 80. The material preferably loops through fastening member 82 and terminates at second end 94b. Over those areas of doubling, the material is preferably held together via, for example, several stitching areas (100), as is common in safety harnesses.

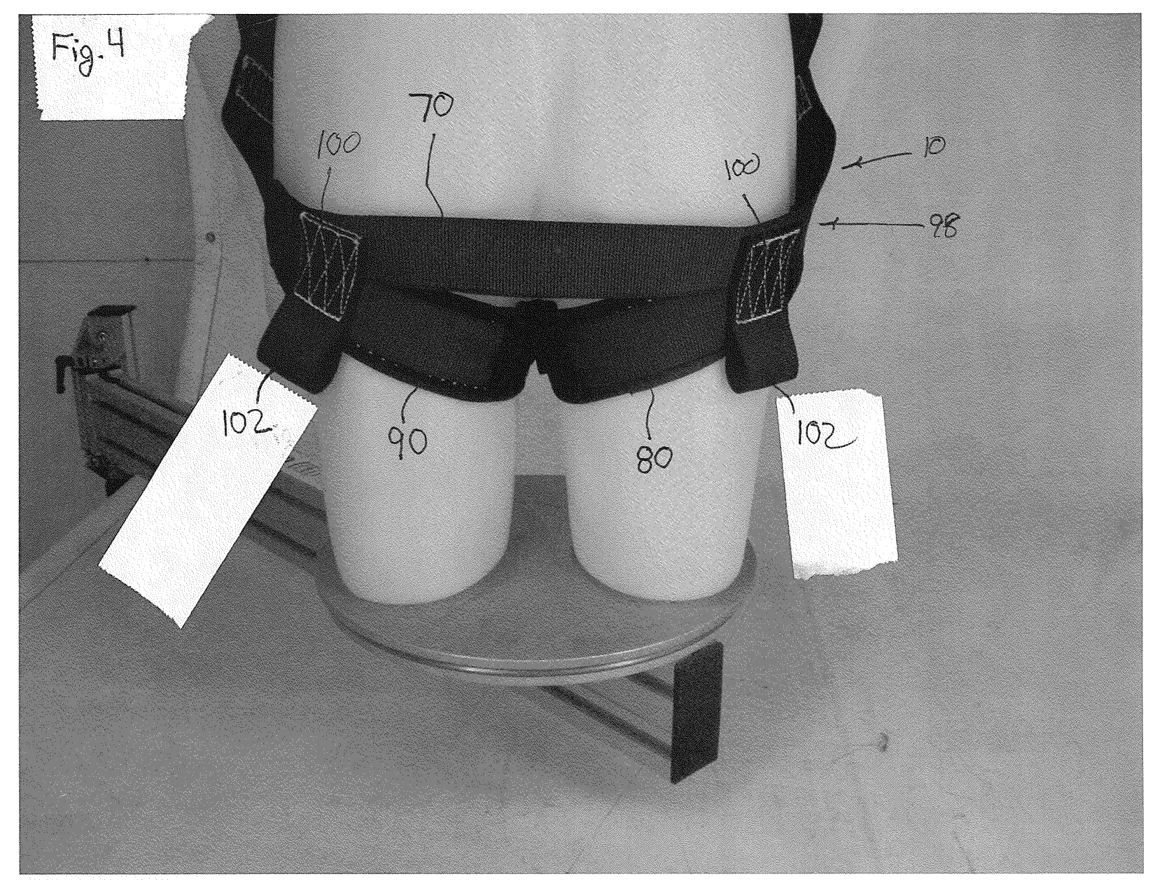

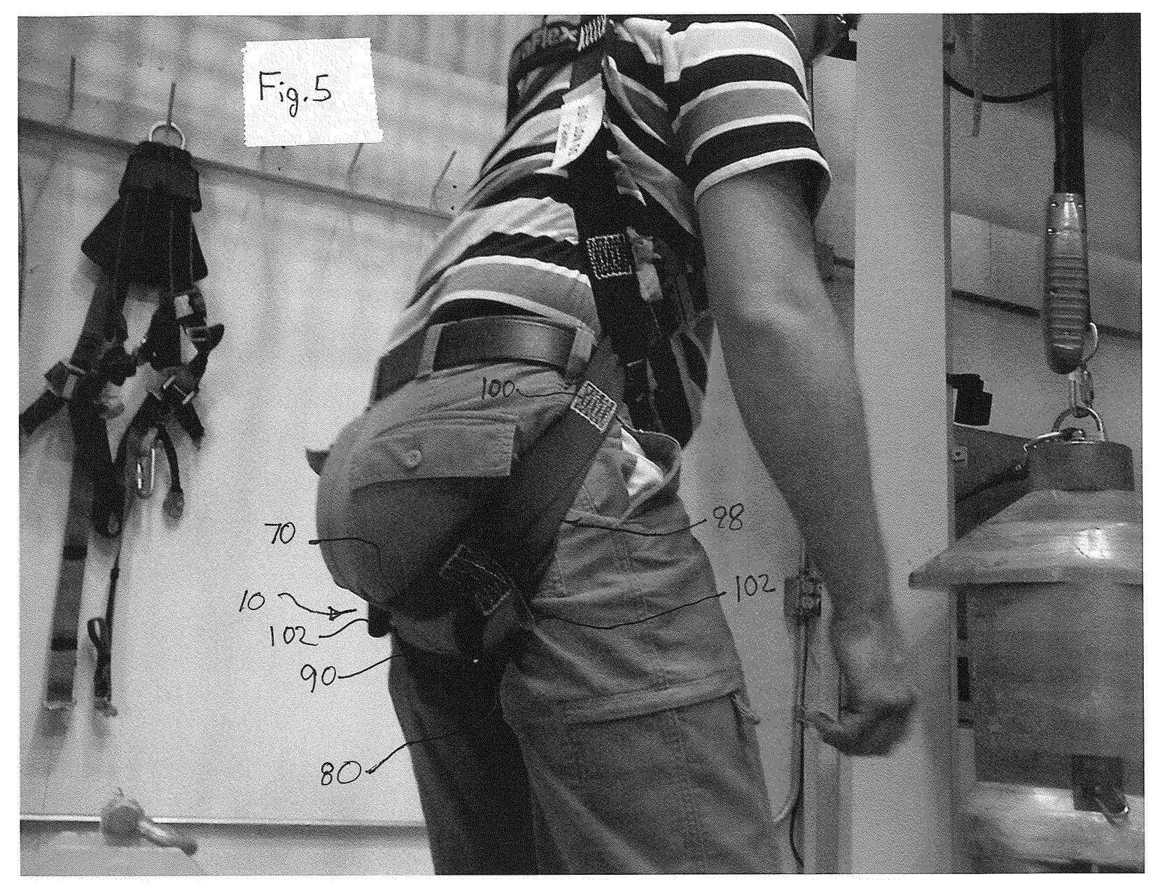

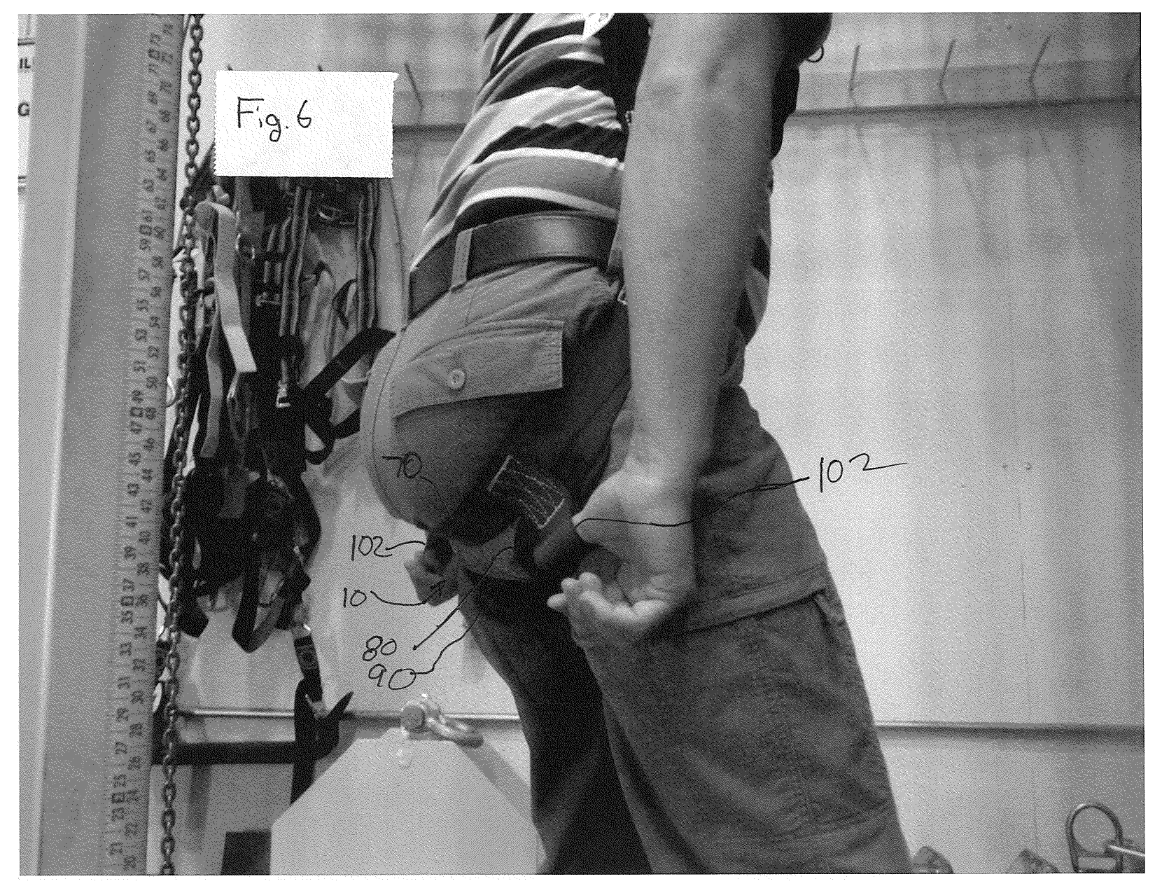

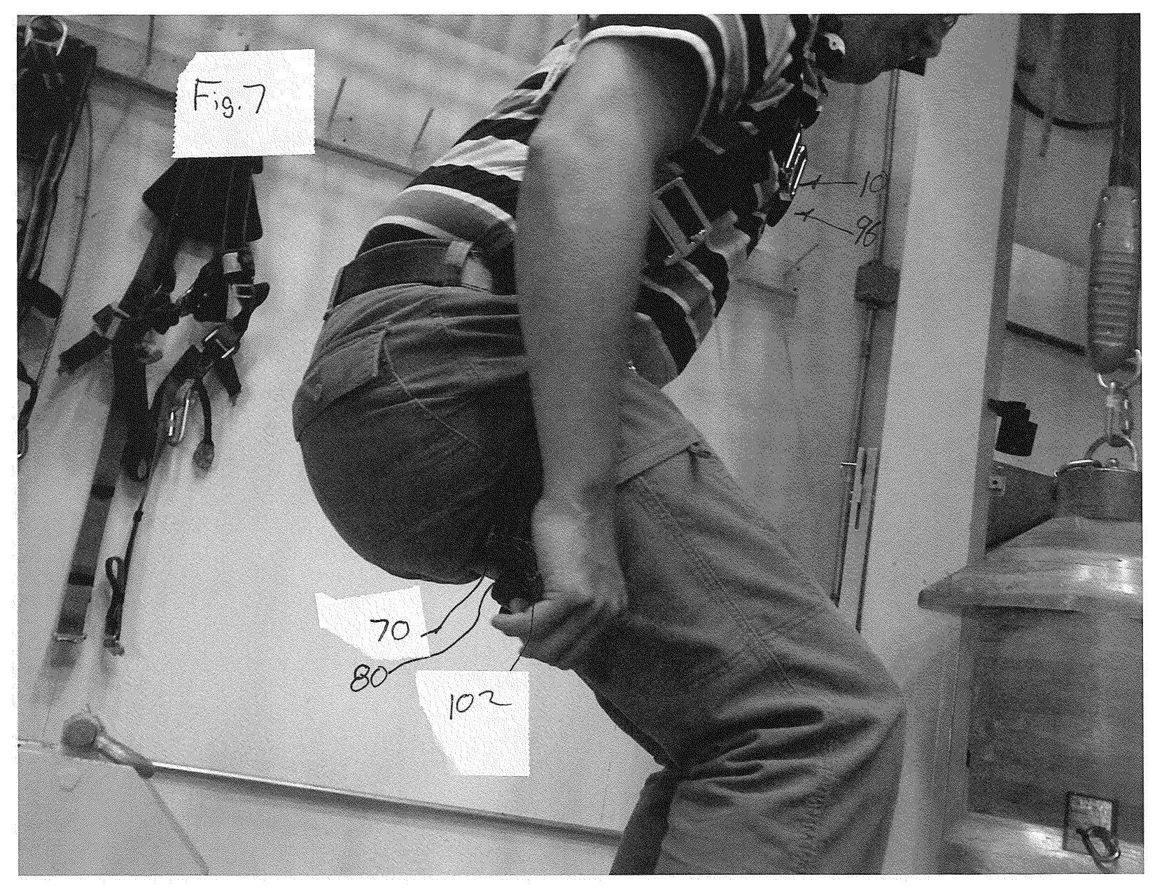

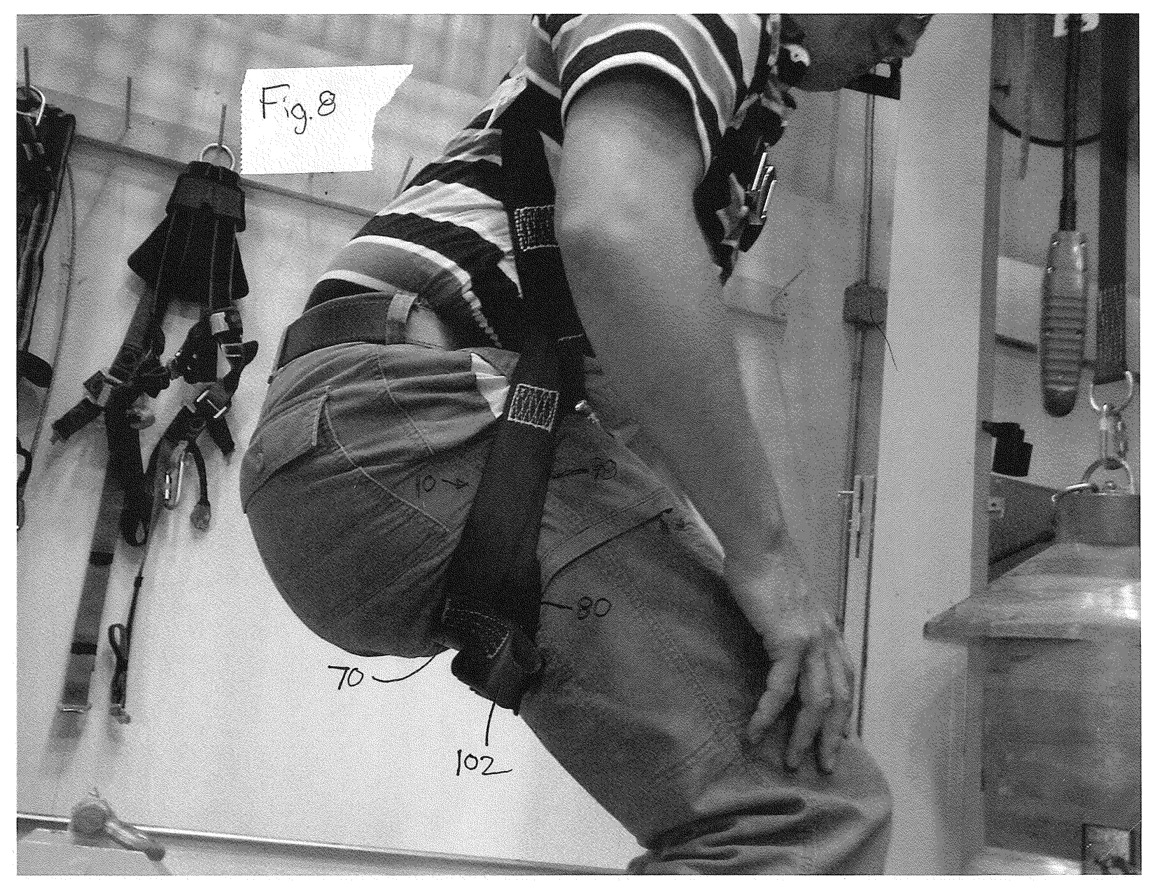

According to this disclosure, the harness 10 advantageously includes a pair of hand engageable members, which are shown in the illustrated embodiment as suspension trauma loops 102, that are each fixed to both the seat strap 70 and a corresponding one of the leg straps 80 and 90, such as by the stitching areas 100, as best seen in FIG. 3. The loops 102 are located on the harness 10 to be positioned on opposite sides from each other on the buttocks of a person wearing the harness 10, as best seen in FIGS. 2 and 4. The loops 102 extend from the seat strap 70 and leg straps 80 and 90 so that each of the loops 102 can be engaged by a corresponding hand of a person wearing the harness to allow the person to move or reposition the seat strap 70 and leg straps 80 and 90 from first positions shown in FIGS. 5 and 6 to second positions shown in FIGS. 7 and 8 (leg strap 90 not visible in FIGS. 7 and 8). More specifically, as shown in FIG. 5, the seat strap 70 has a first position where the seat strap 70 extends across or above the buttocks of the person and the leg straps 80 and 90 have a first position where the leg straps encircle an upper thigh portion of the person, and after the person uses the trauma loops 102 to manually move the straps 70, 80, and 90 to the second positions shown in FIGS. 7 and 8, the seat strap 70 extends across or below the lower buttocks of the person and the leg straps 80 and 90 encircle a lower thigh portion of the person. In the illustrated embodiment and as best seen in FIGS. 6 and 7, each of the trauma loops 102 are advantageously sized so that a thumb or finger of the corresponding hand of the person can be inserted through the loop 102 so the loop 102 encircles the thumb or finger to provide the person with additional grip or purchase on the loop 102 when moving the straps 70, 80, and 90, with the sizing of the loop 102 preventing the remainder of the hand to be inserted into the loop 102. It should be understood that the loops 102 are also functional to allow the person to move the straps 70, 80, and 90 from the second positions shown in FIGS. 7 and 8 to the first positions shown in FIGS. 5 and 6. It should also be understood that, while the loops 102 are shown in the illustration as being sized to prevent the remainder of a hand from being inserted into each of the loops 102, in some applications, it may be desirable for each of the loops 102 to be sized to allow additional parts of the hand, or the entire hand, of a user to be inserted into each of the loops 102.

As shown in FIGS. 5-8 and described above, the suspension trauma loops 102 enable the user to manipulate his or her posture while hanging in the harness 10 into a seated position all the while staying in the safety of the harness 10. Changing the position of the leg straps 80 and 90 from the upper inner thigh area to the bottom mid thigh area will alleviate the pressure on the arteries thus allowing blood to circulate throughout your body. Changing the position of the seat strap 70 from the upper buttocks area to the lower buttocks and/or upper thigh area also helps to alleviate the pressure on the arteries and improve blood circulation while helping to remove body load from the remainder of the harness 10 by accepting more of the body load. In the illustrated embodiments, the suspension trauma loops 102 will be attached to a harness from the factory, are reusable, and do not require any assembly or re-assembly after a fall has occurred.

To use the illustrated suspension trauma loops 102, a person wearing the harness would:

1. Insert thumbs into loops;

2. Push down and forward on loops while lifting up legs;

3. Position legs straps about mid thigh;

4. Remove thumbs; and

5. Reposition as necessary.

While one embodiment of a harness 10 and hand engageable members 102 have been described above, it should be understood that this disclosure anticipates variations from the illustrated embodiments. For example, the hand engageable members 102 can be provided in other forms than the loops 102 that would still allow a person wearing the harness to grasp the hand engageable members 102 and move the straps 70, 80, and 90 as discussed above. As a further example, while the illustrated embodiment shows two hand engageable members 102, it may be possible and desirable in some applications to provide a single hand engageable member 102 or more than two hand engageable members 102. As yet a further example, while the illustrated embodiment shows each of the loops 102 fixed to both the seat strap 70 and the corresponding leg strap 80 and 90, in some applications it may be desirable to fix each of the loops 102 to just the corresponding leg strap 80 and 90 with no connection between the seat strap 70 and the loops 102, while in other applications it may be desirable to fix each of the loops 102 to just the seat strap 70 with no connection between the legs straps 80 and 90 and the loops 102. By way of further example, it may be desirable to incorporate the hand engageable members 102 on other specific embodiments of safety harnesses, many of which are known and which include either a seat strap or leg straps, or both seat straps and leg straps. As another example, while the embodiment disclosed herein includes both an upper portion 96 for securing the harness 10 to the upper torso of a person and a lower portion 98 for securing the harness 10 to the lower torso of a person, in some applications, it may be desirable for the harness 10 to just include a lower portion 98 without the upper portion 96, such as harnesses used for climbing. In view of the many possible variations within the scope of this disclosure, only some of which have been discussed above, it should be understood that there is no intention to claim a specific structure shown or described herein unless it is expressly recited in a claim.

1. A safety harness to be worn by a person, the safety harness comprising at least one of:
a pair of leg straps each adapted to encircle a respective leg of a person wearing the harness, each of the leg straps moveable between a first position where the leg strap encircles an upper thigh portion of a leg of a person wearing the strap and a second position wherein the strap encircles a lower thigh portion of the leg of the person; and
a seat strap adapted to extend across the buttocks of a person wearing the harness and operatively connected to the leg straps, the seat strap moveable from a first position extending across or above the upper buttocks of a person wearing the harness and a second position extending across or below the lower buttocks of a person wearing the harness; and further comprising
at least one hand engageable member operatively connected to the at least one of the pair of leg straps and the seat strap to allow a person wearing the harness to move the at least one of the pair of leg straps and the seat strap between the first and second positions with the harness bearing the weight of the person.

2. The safety harness of claim 1 wherein the at least one hand engageable member is a loop extending from the at least one of pair of leg straps and the seat strap and adapted for engagement by a hand of a person wearing the harness.

3. The safety harness of claim 2 wherein the loop comprises a strap fixed to the at least one of the leg straps and seat strap.

4. The safety harness of claim 3 wherein the loop is a thumb or finger loop sized to accept a thumb of a person wearing the harness but not the remainder of a hand of the person.

5. The safety harness of claim 1 wherein the at least one hand engageable member is a pair of loops operatively connected to the at least one of the leg straps and the seat strap, the loops located on the harness to be positioned on opposite sides of a buttocks from each other on a person wearing the safety harness.

6. The safety harness of claim 5 wherein each of the loops is a thumb or finger loop sized to accept a thumb of a person wearing the harness but not the remainder of a hand of the person.

7. The safety harness of claim 1 wherein the at least one of the leg straps and the seat strap comprises the seat strap, and the at least one hand engageable member is operatively connected to the seat strap to allow a person wearing the harness to move the seat strap from the first position to the second position.

8. The safety harness of claim 7 wherein the at least one hand engageable member is a pair of loops operatively connected to the seat strap, the loops located on the harness to be positioned on opposite sides of a buttocks from each other of a person wearing the safety harness.

9. The safety harness of claim 1 wherein the at least one of the leg straps and the seat strap comprises the leg straps, and the at least one hand engageable member is operatively connected to the leg straps to allow a person wearing the harness to move the leg straps from the first position to the second position.

10. The safety harness of claim 7 wherein the at least one hand engageable member is a pair of loops operatively connected to the leg straps, the loops located on the harness to be positioned on opposite sides of a buttocks from each other on a person wearing the safety harness.

11. The safety harness of claim 10 wherein the at least one of the leg straps and seat strap further comprises the seat strap and wherein each of the loops is fixed to the seat strap and to a corresponding one of the leg straps to allow a person wearing the harness to move the seat strap and the leg straps from the first positions to the second positions.

12. The safety harness of claim 11 wherein each of the loops comprises a strap fixed to the seat strap and a corresponding one of the leg straps.

13. The safety harness of claim 12 wherein each of the loops is sized to accept a thumb of a person wearing the harness but not the remainder of a hand of the person.

14. The safety harness of claim 13 wherein the leg straps, the seat strap and the at least one hand engageable member define a lower seat portion of the harness, and further comprising an upper torso portion operatively connected to the lower seat portion and adapted to secure the harness to the upper torso of a person wearing the harness.

15. The safety harness of claim 14 wherein the upper torso portion comprises a pair of shoulder straps operatively connected to the lower seat portion, each of the shoulder straps configured to extend over a respective shoulder of a person wearing the strap.

16. A method of manipulating a safety harness to alleviate the potential effects of orthostatic intolerance in a person wearing the harness while suspended thereby, the method comprising the steps of:
loading a safety harness with a weight of a person wearing the harness; and
while the safety harness is loaded with the weight of the person wearing the harness, selectively repositioning a strap of the harness from a first position where the strap extends across an upper portion of a lower torso of the person wearing the harness and a second position where the strap extends across a lower portion of the lower torso of the person wearing the harness.

17. The method of claim 16 wherein the step of selectively repositioning comprises the step of selectively repositioning at least one leg strap of the harness from a first position where the strap extends around an upper thigh of a leg of the person wearing the harness to a lower position on the thigh of the leg of the person.

18. The method of claim 16 wherein the step of selectively repositioning comprises the step of selectively repositioning a seat strap of the harness from a first position where the strap extends across or above an upper portion of a buttocks of the person wearing the harness to a lower portion of the buttock or thighs of the person wearing the harness.

19. The method of claim 16 wherein the step of selectively repositioning comprises the step of engaging each hand of the person with a corresponding harness member extending from the strap and using the hands to move the strap to the second position.

20. The method of claim 19 wherein the engaging step comprises inserting one of a finger or thumb of each hand of the person into a corresponding loop extending from the strap.
